(19) United States
(12) Patent Application Publication
(10) Pub. No.: US 2002/0176958 A1
(43) Pub. Date: Nov. 28, 2002

(54) Wiping cloth

(76) Inventors: Thomas D. Nord, Newnan, GA (US); James M. Massengale, Tokyo (JP); Ross T. Murphy, LaGrange, GA (US); Samuel E. Dunson, LaGrange, GA (US); William H. Pace, Newnan, GA (US); Joseph T. Peavy, Helotes, TX (US); Muldrow B. Rigby, Rock Hill, SC (US)

Correspondence Address: Jeffery E. Bacon, Legal Department, M-495, Milliken & Company, PO Box 1926, Spartanburg, SC, 29304, US

(21) Appl. No.: 10/195,010

(22) Filed: Jul. 11, 2002

Related U.S. Application Data
(62) Division of application No. 09/544,426, filed on Apr. 6, 2000.

(51) Int. Cl. B32B 3/02; D04H 11/00

(52) U.S. Cl. 428/85; 442/318

(57) ABSTRACT

A wiping cloth having a fabric with free end pile on opposing surfaces of the fabric, and a hydrophilic treating.

### BACKGROUND

The present invention is directed to wiping cloths.

Wiping cloths are generally used for absorbing, scrubbing, and polishing. Many materials have been selected for use as a wiping cloth. However, the fabric must be selected based upon its contribution to the desired attributes of the wiping cloth. Additional considerations such as soil resistance, lint generation, etc. Furthermore, the selection of fabric for a wiping cloth can influence the life and cost of a wiping cloth. There remains a need for wiping cloths having desirable absorbing, scrubbing, and polishing characteristics, which also have high soil resistance and low lint generation.

### BRIEF DESCRIPTION OF THE DRAWINGS

The present invention can be described with regard to the accompanying drawings where:

FIG. 1 is an illustration of a wiping cloth according to the present invention;

FIG. 2 is an enlarged cross-section of the fabric in the wiping cloth from FIG. 1; and

FIG. 3 is a block diagram illustrating a process for forming a wiping cloth.

### DETAILED DESCRIPTION

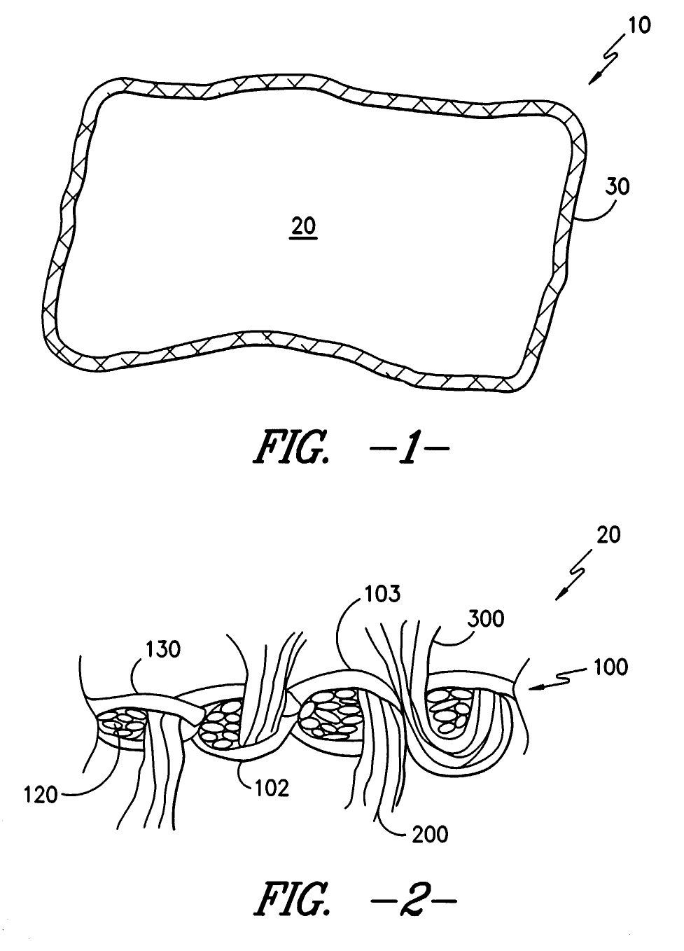

Referring now to the drawings and in particular to FIG. 1, there is illustrated a wiping cloth 10 of the present invention. The wiping cloth 10 generally comprises a fabric 20 with edging 30. The edging 30 helps prevent the fabric 20 from unraveling on the edges and corners. As illustrated, the edging 30 is a thread sewn around the edge of the fabric. However, it is anticipated that the edging 30 could also be an ultrasonic sealing of the fabric 20 on the perimeter of the wiping cloth 10.

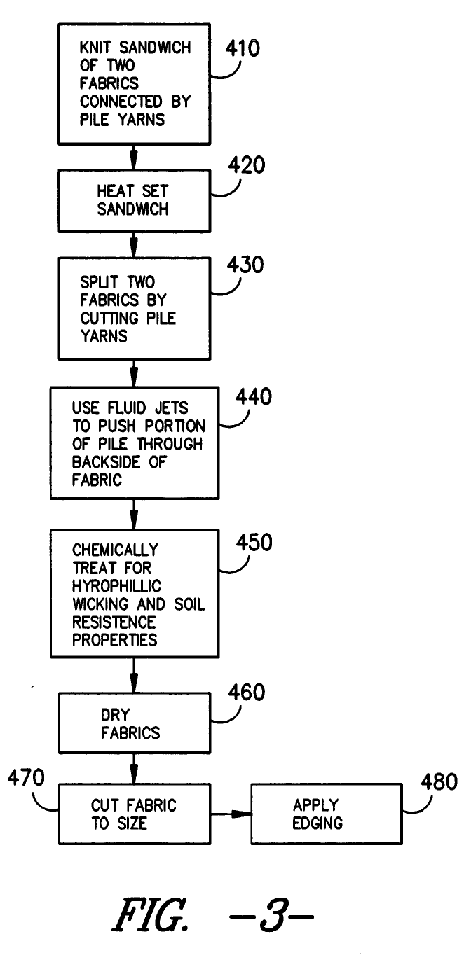

Referring now to FIG. 2, there is shown an enlarged cross-section of the fabric 20 from FIG. 1. The fabric 20 includes a substrate 100 having a first substrate surface 102 and a second substrate surface 103, a plurality of first free end pile yarns 200 extending outwardly from the first substrate surface 120, and a plurality of second free end pile yarns 300 extending from the second substrate surface 103. As illustrated, the substrate 100 is a Raschel knit fabric having course yarns 120 and wale yarns 130. The first pile yarns 200 and the second pile yarns 300 are knotted into the first side 102 of the substrate 100. The first side yarns 200 extend outwardly from the first surface 102 of the substrate 110. A portion of the second pile yarns 300 extend through the substrate 100, and emanate from the second surface 103 of the substrate 100. Another portion of the second pile yarns 300 emanate from the first surface 102 of the substrate 100, pass over at least one course yarn 120 and/or one wale yarn 130, and then pass through the substrate 100 to emanate from the second side 103 of the substrate 100. The wrapping of the second pile yarns 130 around and through yarns of the substrate 100 is believed to provide additional security for inhibiting the ability of the pile yarns 200 and 300 to be removed from the substrate.

A preferred material for the fabric 103 polyester, however, fabrics formed of synthetic such as polyester typically have a lower capability to pick up and retain liquids. Therefore, in accordance with the preferred embodiment of the present invention, the fabric 100 is chemically treated to improve the hydrophilic, wicking, and soil release properties of the fabric 100. A preferred chemical treatment is an ethoxylated polyester. Examples of ethoxylated polyesters include an anionic—ethoxylated sulphinated polyester and high molecular ethoxylated polyester. Such agents are described in U.S. Pat. No. 5,935,484, the content of which is incorporated herein in its entirety by specific reference thereto. It is believed that the additional surface areas created by the open ends of the cut pile yarns 200 and 300, combined with the chemical treatment of the present invention, facilitate an unexpected wicking and retention of liquids by the wiping cloth.

Referring now to FIG. 3, there is shown a block diagram illustrating the process of the present invention for forming a wiping cloth. Sandwich fabric is produced in Step 410 by knitting two Raschel knit fabrics face to face with float yarns interlaced between the two. After the knitted sandwich is produced, the knitted sandwich is heat set in Step 420. The heat set knitted sandwich is then silted in Step 430 to produce two pile fabrics having a substrate with the free end pile yarns emanating from only one surface of the substrate.

In Step 440, a portion of the pile is forced back through the substrate to emanate from the opposing side using fluid jets. The process for pushing the pile fabric through the substrate to the opposing side is known in the art and is described in U.S. Pat. No. 5,235,733, which issued on Aug. 17, 1993, to Charles E. Willbanks et al., and which is hereby incorporated herein in its entirety by specific reference thereto. It is preferred to push 50% of the pile back through the substrate in an irregular or regular pattern that results in a continuous surface of pile yarns on both sides of the substrate. It is believed that the process of using fluid jets to position the pile yarns also results in the removal of lint and/or structures that could break loose during use to become lint. This reduction of lint makes the wiping cloth of the present invention particularly useful for applications such as clean rooms.

After the pile is pushed through the substrate in Step 440, in Step 450 the pile fabric is chemically treated to improve the hydrophilic, wicking and soil resistance of the fabric. In Step 460, the dyed fabric is dried. In Step 470, the fabric is cut into wiping cloths, and in Step 480 the edging is applied.

The present invention can be explained by way of the following example:

### EXAMPLE

A sandwich of two Raschel knitted substrates was knitted face to face using a 1/100/34 56T textured polyester ground yarn as the course yarn, and a (115)70/34 56 warp drawn dull polyester ground yarn as the wale yarn, and a pile yarn of 1/100/100 57 dull textured polyester yarn as the pile yarn connecting the two base fabrics. The fabrics were knitted as a 44-gauge needle bar, single pile bar knit.

After the fabric was knitted, it was heat set and slit to form two identical pile fabrics with the cut pile on one side of each of the two fabrics. The silted pile fabrics are then subjected to impact by multiple, thin, high velocity jet streams on to the pile surface of the fabric. The jets cause approximately 50% of the pile to be forced through the substrate to the other side of the fabric. The result is a fabric with cut pile on both sides.

Following the jet treatment of the fabric, the fabric was then chemically treated to improve the hydrophilic and stain resistance of the material. The chemical treatment was a condensate of dimethyl terephthalic and a high molecular weight polyethylene glycol sold by ABCO Chemical, Roebuck, S.C. under the name LUBRIL QCX. A dye was applied to the fabric at the same time as the fabric was chemically treated to increase the hydrophilic properties. The LUBRIL QCX was applied to the fabric as an aqueous solution having about 16% solids, and being applied to the fabric at a rate of about 3.0% of the weight of the fabric.

Following application of the chemical treatment, the fabric was dried, cut in to appropriate wiping cloth dimensions, and an edging was applied by sewing a thread around the edges of the material.

What is claimed is:

1. A wiping cloth having a fabric comprising:
a substrate fabric having a first side and a second side,
a plurality of first pile yarns extending from the first side of said substrate fabric, and
a plurality of second free end pile yarns extending from the second side of the substrate fabric.

2. The wiping cloth according to claim 1, further comprising ethoxlated polyester applied to the substrate fabric, the first free end piles, and the second free end piles.

3. The wiping cloth according to claim 1, further comprising said substrate fabric being formed of a plurality of yarns, and a plurality of said second free end pile yarns originating from the first side of the substrate fabric, passing around the substrate yarns and through the substrate to emerge from the second side of the substrate fabric.

4. A method of forming a wiping cloth including the steps of:
a) knitting two base fabrics connected by pile yarns;
b) cutting the pile yarns to separate the two substrate fabrics;
c) subjecting the pile surface of at least one of said substrate fabrics to a plurality of jet streams thereby forcing a portion of the pile to pass through substrate fabric and emerge on the opposing side.
